(19) United States
(12) Patent Application Publication
(10) Pub. No.: US 2015/0336797 A1
(43) Pub. Date: Nov. 26, 2015

(54) POROUS CARBON COMPOSITIONS

(71) Applicant: Dow Global Technologies LLC, Midland, MI (US)

(72) Inventors: Hamed H Lakrout, Lake Jackson, TX (US); Maurice J. Marks, Lake Jackson, TX (US); Ludovic Valette, Perrysburg, OH (US); Dwight Latham, Clute, TX (US)

(21) Appl. No.: 14/391,718

(22) PCT Filed: May 17, 2013
(86) PCT No.: PCT/US2013/041561

§ 371 Date: Oct. 10, 2014

Related U.S. Application Data
(60) Provisional application No. 61/660,458, filed on Jun. 15, 2012.

(51) Int. Cl. C01B 31/02; C08J 9/12; F16L 59/02

(52) U.S. Cl. CPC C01B 31/02; F16L 59/028; C08J 9/122

(57) ABSTRACT

A curable liquid carbon precursor formulation for preparing a porous carbon composition including (a) at least one aromatic epoxy resin; (b)(i) at least one aromatic co-reactive curing agent, or (b)(ii) at least one catalytic curing agent, or (b)(iii) a mixture thereof; and (c) at least one porogen; wherein the liquid composition has a neat viscosity of less than 10,000 mPa-s, at 25° C. prior to adding porogen, prior to adding optional components, prior to curing, and prior to carbonizing; and wherein the liquid composition being cured has a carbon yield of at least 35 weight percent disregarding the weight of the porogen and any optional components present in the composition; a process for preparing the porous carbon composition from the above formulation including the steps of curing the formulation, and carbonizing the cured product resulting from curing the formulation such that a porous carbon composition is produced; and a porous carbon composition made by the above process.

### FIELD

The present invention is related to a porous carbon composition and a process for manufacturing the porous carbon composition.

### BACKGROUND

Thermal management is a critical issue for the electronics industry. Over 55 percent (%) of electronics product failures are due to temperature related issues. Reducing temperature of components by 10° C. can double the life of a product. Commonly used materials today for thermal management are metals, such as aluminum and copper, but there are still some unmet needs when using the materials of the prior art such as (1) better heat dissipation (faster and effective), (2) lower thermal stress (CTE match), (3) less weight and volume, and (4) lower cost. Recently, porous carbon compositions have been used in materials for the electronics industry, but the known porous carbon compositions require complex manufacturing processes the make the known porous carbon compositions uneconomically viable.

A number of early references describe manufacturing polymeric foams and subsequently carbonizing the polymeric foams. However, the community progressively focuses on mesophases and pitches for better carbon quality with highly graphitic type of carbon resulting from heat treatments. Nothing in the art discloses the use of a low viscosity epoxy carbon precursor for manufacturing a carbon foam.

Carbon foam was initially produced by carbonization of phenol formaldehyde foam (U.S. Pat. Nos. 3,121,050 and 3,342,555), and by carbonization of partially polymerized furfuryl alcohol with urethane foam forming chemicals (U.S. Pat. No. 3,345,440). According to Chen et al., Carbon, Volume 44, Issue 8, July 2006, Pages 1535-1543, the above known foam has a uniform cell size and moderate mechanical strength. However, according to Prieto et al., Carbon, Volume 50, Issue 5, April 2012, Pages 1904-1912, the main drawback of these known foams is the non-graphitizable nature of the carbon material.

During the 1990s, a generation of carbon foams fabricated from alternative thermoplastic graphitizable precursors such as petroleum-derived, coal-derived and mesophase pitches emerged. Since then, mesophase pitches have been widely used as appropriate precursors for high performance carbon materials due to the mesophase pitches' attractive properties of high coke yield, low softening point, and high fluidity.

Traditional foam-forming processes make use of a blowing technique, or pressure release, to produce foam from the mesophase pitch. These manufacture techniques, although commonly employed in the industry, have many disadvantages. For example, there is no perfect control of the volume fraction of generated pores in the final foam product; and, moreover, the shape and distribution of the pores are difficult, or even impossible, to manage. The additional difficulty is that since mesophase pitch is not dimensionally stable above its softening point, a stabilization treatment is required before the mesophase pitch can be carbonized. Otherwise, the foam structure from a mesophase pitch gets lost by swelling or softening during posterior heat treatments. The stabilization treatment, or alternatively called thermosetting or infusibilization, consists of a heat treatment at low temperature (e.g., 170° C.) for some hours in an air stream at a low flow rate.

Chen et al above have successfully removed the stabilization step by replacing an aromatic mesophasic resin with a low-cost coal, coal N-methyl-2-pyrollidone (NMP) solvent-extracts, petroleum pitch, coal tar pitch, and hydrogenated coal solvent-extracts (coal-based SynPitch). However, coal and petroleum-derived pitches need to be treated before foaming can be achieved. The mesophase AR pitches, on the other hand, can be used in preparing a foaming precursor that can be foamed directly without pretreatment. The major problem with these untreated precursors is that their plastic properties do not normally meet the foaming requirement. The pretreatments mainly involve the polymerization/condensation of pitch by thermal treatment.

U.S. Pat. No. 6,500,401 discloses porous carbon compositions produced by a template approach which involves preparing a mixture of a pyrolizable material and an unpyrolizable material and removing the unpyrolizable material after pyrolysis. The pyrolizable material is defined as an organic compound such sugar or cellulose whereas the unpyrolizable material is defined as inorganic material such as a salt. Carbon foam is obtained after the removal of the unpyrolizable material.

U.S. Pat. No. 6,261,485 discloses porous carbon compositions with relatively uniform pore structure and highly aligned graphitic planes in the struts. This foam is targeted toward making high-temperature sandwich panels for thermal and structural applications.

U.S. Pat. No. 6,241,957 discloses low-cost porous carbon compositions and a process for manufacturing the porous carbon compositions from coal extracts. These foams produced from coal extracts are targeted for a variety of commercial aerospace and military applications.

U.S. Pat. No. 6,217,800 discloses a flexible graphite porous carbon composition material prepared from recycled graphite.

Other known porous carbon compositions include for example high-strength porous carbon compositions produced by chemical vapor infiltration, such as POCOFoam® commercially available from Entegris; and a low temperature pitch-based porous carbon composition commercially available from Honeywell. The pitch-based porous carbon compositions are produced by mixing a mesophase melting at 350° C. and a low-molecular-weight solvent. However, all of the known porous carbon compositions described in the above prior art suffer from the following disadvantages or problems

(1) most coal and petroleum-derived pitches need to be treated before foaming can be achieved; and the pretreatments mainly involve the polymerization/condensation of pitch by thermal treatment; and

(2) mesophase pitch requires a stabilization treatment or the foam structure gets lost by swelling or softening during posterior heat treatments.

The softening temperature of the thermoset thus created by the curing of the liquid carbon precursor is higher than the carbonization temperature. The green carbon foam which is the cured polymeric epoxy does not require an additional treatment step to survive the heat treatment of the carbonization.

The present invention is better because the viscosity of the liquid carbon precursor is low at ambient temperature (about 25° C.) as opposed to AR mesophase or other pitch materials requiring either solvent and therefore additional drying treatments or high temperature processes.

None of the above cited references disclose a low viscosity liquid carbon precursor with a high carbon yield. What is needed in the industry is a low viscosity liquid carbon precursor at ambient temperature without requiring a solvent; and therefore without requiring additional drying treatments or high temperature processes. Furthermore, what is needed in the industry is a high carbon yield low viscosity epoxy formulation that can be cured into a closed cell foam to foam a porous carbon composition that is cost effective and mechanically strong so as to be useful for applications such as the electronics industry.

### SUMMARY

One embodiment of the present invention is directed to a curable liquid carbon precursor formulation for preparing a porous carbon composition comprising (a) at least one aromatic epoxy resin; (b)(i) at least one aromatic co-reactive curing agent, (b)(ii) at least one catalytic curing agent, or (b)(iii) a mixture thereof; and (c) at least one porogen; wherein the liquid composition has a neat viscosity of less than 10,000 mPa-s, at 25° C. prior to adding porogen, prior to adding optional components, prior to curing, and prior to carbonizing; and wherein the liquid composition being cured has a carbon yield of at least 35 weight percent disregarding the weight of the porogen and any optional components present in the composition.

Another embodiment of the present invention is directed to a cured carbon precursor composition for preparing a porous carbon composition comprising a cured reaction product of (a) at least one aromatic epoxy resin; (b)(i) at least one aromatic co-reactive curing agent, or (b)(ii) at least one catalytic curing agent, or (b)(iii) a mixture thereof; and (c) at least one porogen; wherein the liquid composition has a neat viscosity of less than 10,000 mPa-s, at 25° C. prior to adding porogen, prior to adding optional components, prior to curing, and prior to carbonizing; and wherein the cured carbon precursor composition has a carbon yield of at least 35 weight percent disregarding the weight of the porogen and any optional components present in the composition.

Still another embodiment of the present invention is directed to a porous carbon composition comprising a carbonized reaction product of a cured composition of (a) at least one aromatic epoxy resin; (b)(i) at least one aromatic co-reactive curing agent, or (b)(ii) at least one catalytic curing agent, or (b)(iii) a mixture thereof; and (c) at least one porogen; wherein the liquid composition has a neat viscosity of less than 10,000 mPa-s, at 25° C. prior to adding porogen, prior to adding optional components, prior to curing, and prior to carbonizing; and wherein the cured carbon precursor composition has a carbon yield of at least 35 weight percent disregarding the weight of the porogen and any optional components present in the composition.

Yet other embodiments of the present invention are directed to processes for (i) preparing a curable liquid carbon precursor formulation for preparing a porous carbon composition; (ii) preparing a cured carbon precursor composition for preparing a porous carbon composition; and (iii) preparing a porous carbon composition. For example, one embodiment of the present invention is directed to a process for preparing a porous carbon composition starting from a low viscosity liquid epoxy resin formulation including the steps of:

(I) providing a curable liquid carbon precursor formulation for preparing a porous carbon composition comprising admixing (a) at least one aromatic epoxy resin; (b)(i) at least one aromatic co-reactive curing agent, or (b)(ii) at least one catalytic curing agent, or (b)(iii) a mixture thereof; and (c) at least one porogen; wherein the liquid composition has a neat viscosity of less than 10,000 mPa-s, at 25° C. prior to adding porogen, prior to adding optional components, prior to curing, and prior to carbonizing; and wherein the liquid composition being cured has a carbon yield of at least 35 weight percent disregarding the weight of the porogen and any optional components present in the composition;

(II) curing the liquid formulation of step (I) to form a cured carbon precursor composition; wherein the cured carbon precursor has a carbon yield of at least 35 weight percent disregarding the weight of the porogen and any optional components present in the composition; and

(III) carbonizing the cured carbon precursor composition of step (II) to form a porous carbon composition.

### BRIEF DESCRIPTION OF THE DRAWINGS

For the purpose of illustrating the present invention, the drawings show a form of the present invention which is presently preferred. However, it should be understood that the present invention is not limited to the precise subject matter shown in the drawings.

FIG. 1 is a schematic illustration showing a liquid composition sample of the present invention containing particles of porogens before curing the liquid composition.

FIG. 2 is a schematic illustration showing a cured composition sample of the present invention containing particles of porogens after curing the liquid composition of FIG. 1 but before carbonization of the cured composition.

FIG. 3 is a schematic illustration showing a porous carbon composition sample of the present invention after carbonization of the cured composition of FIG. 2.

FIG. 4 is a photograph showing a cross-sectional view of a portion of a cured carbon composition sample of the present invention containing particles of porogens before carbonization of the cured carbon composition.

FIG. 5 is a photograph showing a porous carbon composition sample of the present invention after carbonization of a cured carbon composition sample of the present invention such as shown in FIG. 4.

### DETAILED DESCRIPTION

“Porous carbon composition” herein means a carbon composition having pores, voids, channels, fissures, or cavities of various sizes, shapes, structures and distributions, including for example open cell carbon foams, closed cell carbon foams and mixed open and closed cell carbon foams.

“Porogen” herein means an element that will result in the creation of one or more voids prior to or during carbonization treatment.

“Porosity” here means lack of internal continuity of a piece of material.

In its broadest scope, the present invention is directed to a curable liquid carbon precursor formulation for preparing a porous carbon composition comprising (a) at least one aromatic epoxy resin; (b)(i) at least one aromatic co-reactive curing agent, (b)(ii) at least one catalytic curing agent, or (b)(iii) a mixture thereof; and (c) at least one porogen; wherein the liquid composition has a neat viscosity of less than 10,000 mPa-s, at 25° C. prior to adding porogen, prior to adding optional components, prior to curing, and prior to carbonizing; and wherein the liquid composition being cured has a carbon yield of at least 35 weight percent disregarding the weight of the porogen and any optional components present in the composition.

“Carbonizing”, “carbonization” or “pyrolyzing” herein means removing a significant portion of non-carbon elements from a composition by heating the composition at a temperature of 10° C./minute from 25° C. to 1,000° C. under an inert atmosphere such as nitrogen.

“Carbon yield” with reference to a cured composition herein means the percent weight remaining from a cured sample of a composition treated at 10° C./minute from 25° C. to 1,000° C. under an inert atmosphere, such as nitrogen, disregarding the weight of the porogen and any optional components present in the composition, after carbonization.

The aromatic epoxy resin compound, component (a), useful in the curable liquid carbon precursor formulation can be one aromatic epoxy resin compound or a combination of two or more epoxy resin compounds, wherein at least one of the epoxy resin compounds is an aromatic epoxy resin. For example, one preferred embodiment of the aromatic epoxy resin useful in the present invention may be a divinylarene dioxide.

In one embodiment, the divinylarene dioxide useful in the curable liquid carbon precursor composition of the present invention may include any of the divinylarene dioxides described in U.S. patent application Ser. No. 13/133,510.

In another embodiment, the divinylarene dioxide useful in preparing the curable liquid carbon precursor composition of the present invention may include, for example, any substituted or unsubstituted arene nucleus bearing one or more vinyl groups in any ring position. For example, the arene portion of the divinylarene dioxide may consist of benzene, substituted benzenes, (substituted) ring-annulated benzenes or homologously bonded (substituted) benzenes, or mixtures thereof. The divinylbenzene portion of the divinylarene dioxide may be ortho, meta, or para isomers or any mixture thereof. Additional substituents may consist of H₂O₂-resistant groups including saturated alkyl, aryl, halogen, nitro, isocyanate, or RO—(where R may be a saturated alkyl or aryl). Ring-annulated benzenes may consist of naphthalene, and tetrahydronaphthalene. Homologously bonded (substituted) benzenes may consist of biphenyl, and diphenylether.

The divinylarene dioxide used for preparing the formulations of the present invention may be illustrated generally by chemical Structures I-IV as follows:

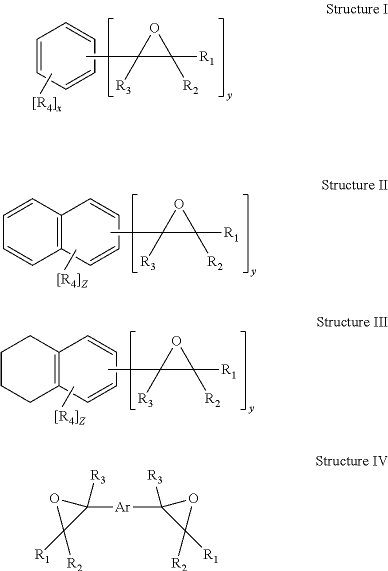

In the above Structures I, II, III, and W of the divinylarene dioxide useful in the present invention, each R₁, R₂, R₃ and R₄ individually may be hydrogen, an alkyl, cycloalkyl, an aryl or an aralkyl group; or a H₂O₂-resistant group including for example a halogen, a nitro, an isocyanate, or an RO group, wherein R may be an alkyl, aryl or aralkyl; x may be an integer of 0 to 4; y may be an integer greater than or equal to 2; x+y may be an integer less than or equal to 6; z may be an integer of 0 to 6; and z+y may be an integer less than or equal to 8; and Ar is an arene fragment including for example, 1,3-phenylene group. In addition, R4 can be a reactive group(s) including epoxide, isocyanate, or any reactive group and Z can be an integer from 0 to 6 depending on the substitution pattern.

In one embodiment, the divinylarene dioxide useful in the present invention may be produced, for example, by the process described in U.S. Patent Provisional Application Ser. No. 61/141,457, filed Dec. 30, 2008, by Marks et al., incorporated herein by reference. In another embodiment, the divinylarene dioxides useful in the present invention are disclosed in, for example, U.S. Pat. No. 2,924,580, incorporated herein by reference.

In still another embodiment, the divinylarene dioxide useful in the present invention may include, for example, divinylbenzene dioxide (DVBDO), divinylnaphthalene dioxide, divinylbiphenyl dioxide, divinyldiphenylether dioxide, or mixtures thereof.

In one preferred embodiment of the present invention, the divinylarene dioxide used in the curable liquid carbon precursor composition of the present invention can be for example DVBDO. Divinylarene dioxides such as for example DVBDO are a class of diepoxides which have a relatively low liquid viscosity but a higher rigidity and crosslink density than conventional epoxy resins.

In another preferred embodiment, the divinylarene dioxide compound useful in the present invention includes, for example, a DVBDO as illustrated by the following chemical formula of Structure V:

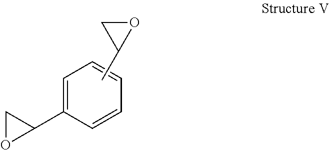

The chemical formula of the above DVBDO compound may be as follows: C₁₀H₁₀O₂; the molecular weight of the DVBDO is 162.2; and the elemental analysis of the DVBDO is: C, 74.06; H, 6.21; and O, 19.73 with an epoxide equivalent weight of 81 g/mol.

Structure VI below illustrates another embodiment of a preferred chemical structure of the DVBDO useful in the present invention:

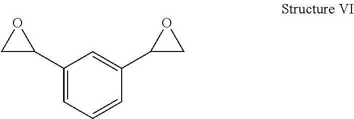 [SMILES: c1cc(C2CO2)cc(C2CO2)c1]

Structure VII below illustrates still another embodiment of a preferred chemical structure of the DVBDO useful in the present invention:

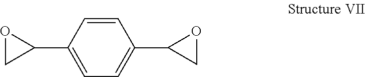 [SMILES: c1cc(C2CO2)ccc1C1CO1]

When DVBDO is prepared by the processes known in the art, it is possible to obtain one of three possible isomers: ortho, meta, and para. Accordingly, the present invention includes a DVBDO illustrated by any one of the above Structures individually or as a mixture thereof. Structures VI and VII above show the meta (1,3-DVBDO) isomer and the para (1,4-DVBDO) isomer of DVBDO, respectively. The ortho isomer is rare; and usually DVBDO is mostly produced generally in a range of from 9:1 to 1:9 ratio of meta (Structure VI) to para (Structure VII) isomers. The present invention preferably includes as one embodiment a range of from 6:1 to 1:6 ratio of Structure VI to Structure VII, and in other embodiments the ratio of Structure VI to Structure VII may be from 4:1 to 1:4 or from 2:1 to 1:2.

In yet another embodiment of the present invention, the divinylarene dioxide may contain quantities (such as for example less than 20 wt %) of substituted arenes and/or arene oxides. The amount and structure of the substituted arenes and/or arene oxides mixed with a divinylarene dioxide composition depends on the process used in the preparation of the divinylarene precursor which is, in turn, used to prepare the divinylarene dioxide. For example, the divinylarene precursor such as divinylbenzene (DVB) can be prepared by the dehydrogenation of diethylbenzene (DEB), and the resultant product composition may contain quantities of ethylvinylbenzene (EVB) and DEB. During the dehydrogenation reaction of DEB, wherein an oxidant such as hydrogen peroxide, the EVB present in the reaction mixture can react with hydrogen peroxide to produce ethylvinylbenzene oxide while DEB remains unchanged. The presence of ethylvinylbenzene oxide and DEB in the divinylarene dioxide can increase the epoxide equivalent weight of the divinylarene dioxide to a value greater than that of a pure divinylarene dioxide compound.

In one embodiment, the divinylarene dioxide, (for example DVBDO) useful in the present invention comprises a low viscosity liquid epoxy resin. For example, the viscosity of the divinylarene dioxide used in the present invention ranges generally from 0.001 Pa-s to 0.1 Pa-s in one embodiment, from 0.01 Pa-s to 0.05 Pa-s in another embodiment, and from 0.01 Pa-s to 0.025 Pa-s in still another embodiment, at 25° C.

One advantageous property of the divinylarene dioxide useful in the present invention is its rigidity. The rigidity property of the divinylarene dioxide is measured by a calculated number of rotational degrees of freedom of the dioxide excluding side chains using the method of Bicerano described in Prediction of Polymer Properties, Dekker, New York, 1993. The rigidity of the divinylarene dioxide used in the present invention may range generally from 6 to 10 rotational degrees of freedom in one embodiment, from 6 to 9 rotational degrees of freedom in another embodiment, and from 6 to 8 rotational degrees of freedom in still another embodiment.

The aromatic epoxy resin useful in the present invention curable liquid carbon precursor composition may include a wide variety of aromatic epoxy resins known in the art other than the divinylarene dioxide. The aromatic epoxy resin may be may be substituted or unsubstituted. The aromatic epoxy resin may be monomeric or polymeric. The aromatic epoxy resin may include a single aromatic epoxy resin or may include a combination of two or more aromatic epoxy resins.

For example, the aromatic epoxy resin useful in the present invention may include, one or more aromatic epoxy resin compounds described in Pham, H. Q. and Marks, M. J., Epoxy Resins, the Kirk-Othmer Encyclopedia of Chemical Technology; John Wiley & Sons, Inc.: online Dec. 4, 2004 and in the references therein; in Lee, H. and Neville, K., Handbook of Epoxy Resins, McGraw-Hill Book Company, New York, 1967, Chapter 2, pages 2-1 to 2-33, and in the references therein; May, C. A. Ed., Epoxy Resins: Chemistry and Technology, Marcel Dekker Inc.: New York, 1988 and in the references therein; and in U.S. Pat. No. 3,117,099; all of which are incorporated herein by reference.

Some of the aromatic epoxy resin compounds useful in the present invention include for example epoxy compounds based on reaction products of polyfunctional phenols, aromatic amines, or aminophenols with epichlorohydrin. A few non-limiting embodiments include, for example, bisphenol A diglycidyl ether, bisphenol F diglycidyl ether, resorcinol diglycidyl ether, and triglycidyl ethers of p-aminophenols. Other suitable epoxy compounds known in the art include for example reaction products of epichlorohydrin with o-cresol novolacs, hydrocarbon novolacs, and, phenol novolacs. The epoxy compound may also be selected from commercially available products such as for example, D.E.R. 331®, D.E.R.332, D.E.R. 354, D.E.R. 580, D.E.N. 425, D.E.N. 431, or D.E.N. 438 epoxy resins available from The Dow Chemical Company.

As aforementioned, the curable liquid carbon precursor composition can be prepared by admixing (a) the at least one aromatic epoxy resin described above with (b)(i) at least one aromatic co-reactive curing agent, or (b)(ii) at least one catalytic curing agent, or (b)(iii) a mixture of the at least one aromatic co-reactive curing agent and the at least one catalytic curing agent.

An “aromatic co-reactive curing agent” herein means an aromatic compound bearing functional groups which react with the epoxide of the aromatic epoxy resin to effect curing by condensation of the epoxide groups of the aromatic epoxy resin with the functional groups of the aromatic co-reactive curing agent.

A “catalytic curing agent” herein means a compound which reacts with the epoxide group of the aromatic epoxy resin to initiate curing of the aromatic epoxy resin by epoxide homopolymerization.

The at least one aromatic co-reactive curing agent or the at least one catalytic curing agent of the carbon precursor composition of the present invention can include for example one or a combination of two or more of the above curing agents. The aromatic co-reactive curing agent and the catalytic curing agent of the carbon precursor composition useful in the present invention may be selected from any aromatic co-reactive curing agents or any catalytic curing agents for epoxy resins known in the art.

For example, the aromatic co-reactive curing agent (also referred to as a hardener or cross-linking agent) useful in the present invention may be any aromatic compound having an active group being reactive with the reactive epoxy group of the epoxy resin. The chemistry of such curing agents is described in the previously referenced books on epoxy resins. The aromatic co-reactive curing agent useful in the present invention includes nitrogen-containing compounds such as amines and their derivatives; oxygen-containing compounds such as carboxylic acid terminated polyesters, anhydrides, phenol-formaldehyde resins, amino-formaldehyde resins, phenol, bisphenol A and cresol novolacs, and phenolic-terminated epoxy resins.

In one preferred embodiment, diaminodiphenylsulfone and their isomers, aminobenzoates, various acid anhydrides, phenol-novolac resins and cresol-novolac resins, for example, may be used in the present invention, but the present invention is not restricted to the use of these compounds.

The aromatic co-reactive curing agent of choice may depend on the aromatic epoxy resin used in the formulation. Generally, the aromatic co-reactive curing agent useful in the present invention may be selected from, for example, but are not limited to, phenols, benzoxazines, aromatic anhydrides, aromatic amines, aromatic carbodiimides, aromatic polyesters, aromatic polyisocyanates, and mixtures thereof. In the cases of a divinylarene dioxide used as the aromatic epoxy resin the aromatic co-reactive curing agent can also include a phenol, diphenol, or polyphenol.

In one embodiment, the at least one aromatic co-reactive curing agent may include one or more of aromatic amines such as methylenedianiline (MDA), toluenediamine (TDA), diethyltoluenediamine (DETDA), diaminodiphenylsulfone (DADS), polyphenols such as bisphenol A, bisphenol F, 1,1-bis(4-hydroxyphenyl)-ethane, hydroquinone, resorcinol, catechol, tetrabromobisphenol A, novolacs such as phenol novolac, bisphenol A novolac, hydroquinone novolac, resorcinol novolac, naphthol novolac, anhydrides such as phthalic anhydride, trimellitic anhydride, and mixtures thereof.

In a preferred embodiment, the aromatic co-reactive curing agent blended with the at least one aromatic epoxy resin such as for example a divinylarene dioxide in preparing the curable carbonized composition liquid precursor of the present invention may comprise, for example, any compound adapted for providing a carbon yield of greater than 35 percent when the compound is subjected to carbonization or pyrolysis. In one embodiment, the aromatic co-reactive curing agent adapted for providing a high carbon yield may include for example a phenolic compound including a monophenol, a diphenol, a polyphenol, or mixtures thereof. The monophenol comprises can comprise for example a phenol such as p-cresol or m-cresol or other phenol, and mixtures thereof. One preferred embodiment includes a phenol compound useful for the curable composition of the present invention, such as for example p-cresol.

Generally, the ratio r of epoxide equivalents from the aromatic epoxy resin to the co-reactive groups of the aromatic co-reactive curing agent adapted for providing a high carbon yield used in the present invention, may be for example, from 0.1 to 10 in one embodiment, from 0.2 to 8 in another embodiment; from 0.4 to 6 in still another embodiment; and from 1 to 5 in yet another embodiment. When r is greater than 1.0, after curing the excess epoxide may remain unreacted or may be reacted into the thermoset network. When the aromatic epoxy resin is a divinylarene dioxide and the aromatic co-reactive curing agent is a phenol, r is defined as explained in co-pending U.S. Provisional Patent Application No. 61/660,397.

The catalytic curing agent useful in the present invention may include, for example, Bronsted acids, Lewis acids, Lewis bases, alkali bases, Lewis acid-Lewis base complexes, quaternary ammonium compounds, quaternary phosphonium compounds, or mixtures thereof. Suitable examples of Bronsted acids include sulfuric acid, sulfonic acids, perchloric acid, phosphoric acid, partial esters of phosphoric acid, and mixtures thereof. One suitable example of a Lewis acid includes boron trifluoride. Suitable examples of Lewis bases include tertiary amines, imidazoles, amidines, substituted ureas and mixtures thereof. One suitable example of an alkali base includes potassium hydroxide. One suitable example of a Lewis acid-Lewis base complex includes boron trifluoride-ethylamine complex. One suitable example of a quaternary ammonium compound is benzyltrimethylammonium hydroxide. One suitable example of a quaternary phosphonium compound is tetrabutylphosphonium hydroxide.

In addition, when an aromatic epoxy resin such as a divinylarene dioxide is used, the catalytic curing agent useful in the present invention can include the latent catalysts described in co-pending U.S. Provisional Patent Application No. 61/660,403.

Generally, the amount of catalytic curing agent used in the present invention, may be for example, from 0.01 wt % to 20 wt % in one embodiment, from 0.1 wt % to 10 wt % in another embodiment; from 0.1 wt % to 5 wt % in still another embodiment; and from 0.1 wt % to 3 wt % catalyst in yet another embodiment. The use of lower levels of catalytic curing agent would reduce reactivity and would result in less crosslinked network; and the use of higher levels of catalytic curing agent would be uneconomical.

In order to produce the curable formulation useful for preparing a porous carbon composition, a porogen is added to the curable formulation. In one embodiment, the porogen added to the curable formulation of the present invention can be a single porogen compound or a combination of two or more different porogen compounds.

For example, the porogen useful for the curable formulation can be a blowing agent, a dispersed gas, a sacrificial template, a hollow material, or combinations thereof.

In one embodiment, the blowing agent includes a liquid having a boiling point of less than 150° C. such as water, a liquid hydrocarbon, a fluorocarbon, a chlorocarbon, a chlorofluorocarbon, alcohols, ketones, ethers, esters, water, and mixtures thereof.

In another embodiment, the dispersed gas can include a gas having a boiling point of less than 20° C. such as air, nitrogen, gaseous hydrocarbons, carbon dioxide, and mixtures thereof.

Chemical blowing agents which decompose (i.e., activated) by heat to produce a gaseous product which then forms a foam product can be used in the present invention.

Physical blowing agents useful in the present invention include for example permanent gases such as N₂, CO₂, fluorocarbons, hydrofluorocarbons, hydrofluoroolefins, chlorocarbons, chlorofluorocarbons, hydrochlorofluorocarbons, water, other inert gases such as SF6, or mixtures thereof.

In another embodiment, the chemical blowing agents useful in the present invention, include for example, chemical blowing agents through which pores are produced by the product of a chemical reaction. Examples of chemical blowing agents include sodium bicarbonate, citric acid, hydrazine and other nitrogen-based materials such as azodicarbonamide, p-toluenesulfonylhydrazide, p-toluenesulfonyl semicarbazide; 4,4-oxybisbenzenesulfonylhydrazide, 5-phenyltetrazole and dinitrosopenta-methylenetetramine. In addition, reactions between isocyanates and water can be used to produce pores. Other blowing agents useful in the present invention may include those described in Rhomie et al., “Blowing Agents”, Encyclopedia Of Polymer Science and Technology, (DOI: 10.1002/0471440264.pst032; Feb. 15, 2011).

The sacrificial template may include a polymer particle having a thermal degradation of less than 600° C., including for example polymers and copolymers of styrene, methyl methacrylate, butadiene, ethylene, propylene, acrylonitrile, and mixtures thereof.

Examples of hollow material that can be added as the porogen in the curable formulation can be of any shape such as spheres, tubes, cylindrical, discs, cubes, stars, and mixtures thereof.

In another embodiment, the epoxy resin or the curing agent used in the curable formulation can be a porogen.

Generally, the amount of the porogen compound useful in the present invention, may be for example, from 0.1 volume percent (vol %) to 99.9 vol % in one embodiment, from 1 vol % to 99 vol % in another embodiment; from 10 vol % to 90 vol % in still another embodiment; and from 20 vol % to 80 vol % in yet another embodiment.

In another preferred embodiment, the porogen compound can be a solvent or can be blended with a solvent in preparing the curable formulation of the present invention.

In preparing the curable liquid carbon precursor composition of the present invention, optional compounds can be added to the curable liquid carbon precursor composition including for example at least one curing catalyst. A “curing catalyst” or “cure catalyst” herein means a compound used to facilitate the reaction of the at least one aromatic epoxy resin with the aromatic co-reactive curing agent compound. The curing catalyst may be selected based on the epoxy resin employed and the aromatic co-reactive curing agent employed in the present invention composition.

In one illustrative embodiment when the epoxy resin is for example a divinylarene dioxide and the curing agent is for example a phenol, the optional curing catalyst useful in the present invention may include at least one acid compound-related cure catalyst to facilitate the reaction of the divinylarene dioxide compound with the phenol. In one embodiment, the catalyst useful in the present invention may include, for example, any one or more of the catalysts described in U.S. Provisional Patent Application Ser. No. 61/556,979, such as for example Bronsted acids (e.g., CYCAT® 600 commercially available from Cytec), Lewis acids, and mixtures thereof. In another embodiment, the catalysts may include for example a latent alkylating ester such as for example, any one or more of the catalysts described in WO 9518168.

In another embodiment, the latent alkylating ester cure catalyst may include for example the esters of sulfonic acids such as methyl p toluenesulfonate (MPTS), ethyl p-toluenesulfonate (EPTS), and methyl methanesulfonate (MMS); esters of α-halogenated carboxylic acids such as methyl trichloroacetate and methyl trifluoroacetate; and esters of phosphonic acids such as tetraethylmethylene-diphosphonate; or any combination thereof. One preferred embodiment of the cure catalyst used in the present invention may include for example MPTS. Other curing catalysts useful in the present invention may include for example those described in co-pending U.S. Provisional Patent Application No. 61/660,397.

Generally, the amount of catalytic curing agent or optional cure catalyst used in the present invention, may be for example, from 0.01 wt % to 20 wt % in one embodiment, from 0.1 wt % to 10 wt % in another embodiment; from 0.1 wt % to 5 wt % in still another embodiment; and from 0.1 wt % to 3 wt % catalyst in yet another embodiment. The use of lower levels of catalytic curing agent or optional cure catalyst would reduce reactivity and would result in less crosslinked network; and the use of higher levels of catalytic curing agent or optional cure catalyst would be uneconomical.

The curable formulation of the present invention may include as an optional compound at least one other second epoxy compound different from the above-described first aromatic epoxy resin such as DVBDO. For example, the second epoxy compound may include one epoxy compound or may include a combination of two or more epoxy compounds. The epoxy compounds useful in the present invention are those compounds may include a wide variety of epoxy compounds known in the art. For example, the epoxy compound may be saturated or unsaturated, aliphatic, cycloaliphatic, aromatic or heterocyclic and may be substituted. The epoxy compound may be monomeric or polymeric.

For example, the formulation of the present invention may include, one or more epoxy compounds known in the art such as epoxy compounds described in Pham, H. Q. and Marks, M. J., Epoxy Resins, the Kirk-Othmer Encyclopedia of Chemical Technology; John Wiley & Sons, Inc.: online Dec. 4, 2004; in Lee, H. and Neville, K., Handbook of Epoxy Resins, McGraw-Hill Book Company, New York, 1967, Chapter 2, pages 2-1 to 2-33, and in the references therein; May, C. A. Ed., Epoxy Resins: Chemistry and Technology, Marcel Dekker Inc.: New York, 1988; and in U.S. Pat. No. 3,117,099; all which are incorporated herein by reference.

Some of the epoxy compounds useful as the second epoxy resin may include for example epoxy compounds based on reaction products of polyfunctional alcohols, phenols, cycloaliphatic carboxylic acids, aromatic amines, or aminophenols with epichlorohydrin. A few non-limiting embodiments include, for example, bisphenol A diglycidyl ether, bisphenol F diglycidyl ether, resorcinol diglycidyl ether, and triglycidyl ethers of para-aminophenols. Other suitable epoxy compounds known in the art include for example reaction products of epichlorohydrin with o-cresol novolacs, hydrocarbon novolacs, and, phenol novolacs. The epoxy compound may also be selected from commercially available products such as for example, D.E.R. 331®, D.E.R.332, D.E.R. 354, D.E.R. 580, D.E.N. 425, D.E.N. 431, D.E.N. 438, D.E.R. 736, or D.E.R. 732 epoxy resins available from The Dow Chemical Company.

When a single aromatic epoxy resin is used herein, or when an aromatic epoxy resin is used in combination or blend with one or more other non-aromatic, aliphatic, or cycloaliphatic epoxy compounds, the total amount of the epoxy resin used in the formulation useful in the present invention may range generally from 0.5 weight percent (wt %) to 100 wt % in one embodiment, from 1 wt % to 99 wt % in another embodiment, from 2 wt % to 98 wt % in still another embodiment, and from 5 wt % to 95 wt % in yet another embodiment, depending on the fractions of the other ingredients in the reaction product composition.

Other optional compounds that may be added to the curable liquid carbon precursor composition of the present invention may include compounds that are normally used in curable resin formulations known to those skilled in the art. For example, the optional components may comprise compounds that can be added to the composition to enhance application properties (e.g. surface tension modifiers or flow aids), reliability properties (e.g. adhesion promoters) the reaction rate, the selectivity of the reaction, and/or the catalyst lifetime.

Other optional compounds that may be added to the curable liquid carbon precursor composition may include, for example, a solvent to lower the viscosity of the formulation even further from the initial viscosity of the composition; other epoxy resins different from the aromatic epoxy resin (e.g., aliphatic glycidyl ethers or cycloaliphatic epoxy resins); other curing agents different from aromatic co-reactive curing agents and catalytic curing agents; fillers; pigments; toughening agents; flow modifiers; adhesion promoters; diluents; stabilizers; plasticizers; curing catalysts; catalyst de-activators; flame retardants; aromatic hydrocarbon resins, coal tar pitch; petroleum pitch; carbon nanotubes; graphene; carbon black; carbon fibers, or mixtures thereof.

In one preferred embodiment, the curable liquid carbon precursor formulation for preparing a porous carbon composition can include an additional epoxy resin different from the aromatic epoxy resin, an additional curing agent different from the aromatic co-reactive curing agent and different from the catalytic curing agent, a filler, a reactive diluent, a flexibilizing agent, a processing aide, a toughening agent, or a mixture thereof.

Generally, the amount of the other optional compounds, when used in the present invention, may be for example, from 0 wt % to 90 wt % in one embodiment, from 0.01 wt % to 80 wt % in another embodiment; from 0.1 wt % to 65 wt % in still another embodiment; and from 0.5 wt % to 50 wt % curing agent in yet another embodiment.

One embodiment for preparing the above-described curable high carbon yield low neat viscosity liquid carbon precursor formulation or composition includes, for example the step of admixing (a) at least one aromatic epoxy resin; (b)(i) at least one aromatic co-reactive curing agent, (b)(ii) at least one catalytic curing agent, or (b)(iii) a mixture thereof; and (c) at least one porogen; wherein the liquid composition has a neat viscosity of less than 10,000 mPa-s, at 25° C. prior to adding porogen, prior to adding optional components, prior to curing, and prior to carbonizing; and wherein the liquid composition being cured has a carbon yield of at least 35 weight percent disregarding the weight of the porogen and any optional components present in the composition; and (d) optionally, at least one cure catalyst or other optional ingredients as desired.

The compounds used in making the curable liquid carbon precursor composition are beneficially low viscosity materials that mix without special effort. For example, the preparation of the curable liquid carbon precursor composition of the present invention is easily achieved by blending the ingredients of the composition with a magnetic stir bar mixer or a pail mixer. For example, the curable liquid carbon precursor composition can be mixed with a standard pail mixer at from 1 rpm to 200 rpm.

The required and optional components or ingredients of the curable liquid carbon precursor composition or formulation of the present invention are typically mixed and dispersed at a temperature enabling the preparation of an effective curable composition having the desired balance of properties for a particular application. For example, the temperature during the mixing of the components may be generally from −10° C. to 100° C. in one embodiment, and from 0° C. to 50° C. in another embodiment. Lower mixing temperatures help to minimize reaction of the resin and hardener components to maximize the pot life of the formulation.

As one illustrative embodiment and not be limited thereby, a divinylbenzene dioxide, a p-cresol, a cure catalyst, and other desirable and optional additives, for example an additional epoxy resin, can be admixed together to form the curable liquid carbon precursor composition of the present invention.

The preparation of the curable liquid carbon precursor composition of the present invention, and/or any of the steps thereof, may be a batch or a continuous process. The mixing equipment used in the process may be any vessel and ancillary equipment well known to those skilled in the art.

The curable liquid carbon precursor composition useful in the present invention, prior to adding any optional compounds, prior to curing, and prior to carbonizing, has a neat viscosity of less than 10,000 mPa-s at 25° C. For example, the curable liquid carbon precursor composition without optional compounds and prior to curing and carbonizing has a neat viscosity of generally less than 10,000 mPa-s in one embodiment, from 1 mPa-s to 5,000 mPa-s in another embodiment, from 5 mPa-s to 3,000 mPa-s in still another embodiment, and from 10 mPa-s to 1,000 mPa-s in yet another embodiment, at 25° C. In other embodiments, the neat viscosity of the curable liquid carbon precursor composition prior to curing can include 1 mPa-s or greater, 5 mPa-s or greater, or 10 mPa-s or greater. In other embodiments, the neat viscosity of the curable liquid carbon precursor composition prior to curing can include 10,000 mPa-s or lower, 5,000 mPa-s or lower, 3,000 mPa-s or lower or 1,000 mPa-s or lower.

The above low viscosity formulation (lower than 10,000 mPa-s) can advantageously be used without having to dilute the formulation with a solvent to obtain the low viscosity. In addition, the formulation advantageously shows good affinity to carbon surfaces and ultimately provides a high carbon yield (e.g., higher than 35%). In another embodiment, the process for preparing the carbon-carbon composite is beneficial because the use of the low viscosity formulation reduces the number of densification cycles (typically, by one or more cycles) to deliver a uniformly densified carbon-carbon composite (i.e., a composite with no interphase transition between carbon matrix such as carbon fibers and impregnated resin) as well as a carbon-carbon composite with minimum porosity when densified (typically, above 10 lbs/cubic feet).

One advantage of the low viscosity of the curable liquid carbon precursor composition of the present invention is that the low viscosity enables a processable amount of resin pick-up by the carbon matrix such as carbon fibers.

In addition to having a low viscosity, the curable liquid carbon precursor composition, prior to curing, has a surface tension that can be from 10 mN/m to 70 mN/m at 25° C. in one embodiment, from 20 mN/m to 60 mN/m in another embodiment, and from 30 mN/m to 60 mN/m in still another embodiment. In other embodiments, the surface tension of the curable liquid carbon precursor composition prior to curing can include 10 mN/m or greater, 20 mN/m or greater, or 30 mN/m or greater. In other embodiments, the surface tension of the curable liquid carbon precursor composition prior to curing can include 70 mN/m or lower or 60 mN/m or lower.

Furthermore, the curable liquid carbon precursor composition of the present invention may have a wettability property sufficient to easily and efficiently wet the surface of a carbon substrate or member, that is, the liquid precursor has affinity between a liquid and a surface translating into the ability of the liquid to spread on the surface of the substrate.

In another embodiment of the present invention, the above described curable formulation can be cured to form a cured carbon precursor composition which in turn can be used to prepare a porous carbon composition. For example, the cured carbon precursor composition comprises a cured reaction product of (a) at least one aromatic epoxy resin; (b)(i) at least one aromatic co-reactive curing agent, or (b)(ii) at least one catalytic curing agent, or (b)(iii) a mixture thereof; and (c) at least one porogen; wherein the liquid composition has a neat viscosity of less than 10,000 mPa-s, at 25° C. prior to adding porogen, prior to adding optional components, prior to curing, and prior to carbonizing; and wherein the cured carbon precursor composition has a carbon yield of at least 35 weight percent disregarding the weight of the porogen and any optional components present in the composition.

The cured carbon precursor composition of the present invention includes at least one porogen that generates pores during curing to form a cured porous carbon precursor composition. In another embodiment, the cured carbon precursor composition includes at least one porogen such as for example a dispersed gas, a blowing agent, or mixtures thereof.

The first step of producing a cured carbon precursor composition of the present invention is providing a curable formulation of the present invention as described above and then curing the curable formulation.

The process of the present invention includes curing the aforementioned curable liquid carbon precursor composition to form a cured material or cured product, i.e., a cured carbon precursor composition. The curing of the curable liquid carbon precursor composition may be carried out at a predetermined temperature and for a predetermined period of time sufficient to cure the liquid carbon precursor composition. For example, the temperature of curing the curable liquid carbon precursor composition or formulation may be generally from 10° C. to 350° C. in one embodiment; from 25° C. to 200° C. in another embodiment, from 100° C. to 190° C. in still another embodiment; and from 125° C. to 175° C. in yet another embodiment. In other embodiments, the temperature of curing can include 10° C. or greater, 25° C. or greater, 100° C. or greater, or 125° C. or greater. In other embodiments, the temperature of curing can include 350° C. or lower, 200° C. or lower, 190° C. or lower, or 175° C. or lower.

Generally, the curing time for curing the curable liquid carbon precursor composition or formulation may be chosen between 1 minute to 90 days in one embodiment, 2 minutes to 7 days, 3 minutes to 1 day, 5 minutes to 8 hours, to between 7 minutes to 4 hours in another embodiment, and between 10 minutes to 2 hours in still another embodiment. In other embodiments, the time of curing can include 1 minute or greater, 2 minutes or greater, 3 minutes or greater, 5 minutes or greater, 7 minutes or greater, or 10 minutes or greater. In other embodiments, the time of curing can include 90 days or lower, 7 days or lower 1 day or lower, 8 hours or lower, 4 hours or lower, or 2 hours or lower.

The curing process can include the step molding the formulation by pouring the formulation into a mold prior to curing and carbonizing. Alternatively, any other shaping or pre-forming techniques known in the art can be used. For example, the molding step of the process can include injecting, casting, coating, extruding, pouring, spraying and mixtures thereof prior to curing and carbonizing.

The divinylarene dioxide of the present invention such as DVBDO, which is one embodiment of the epoxy resin component of the curable composition of the present invention, may be used as the sole resin to form the epoxy matrix in the final curable liquid carbon precursor composition or formulation; or the divinylarene dioxide resin may be used in combination with another epoxy resin that is different from the divinylarene dioxide as the epoxy component in the final curable liquid carbon precursor composition or formulation.

Carbonizing the cured material as described herein provides a carbonized composition from the cured material. The carbon yield of the cured composition is measured disregarding the weight of the porogen and any optional components present in the composition; and is measured by Thermogravimetric Analysis (TGA). The cured material advantageously has a carbon yield of generally at least 35 wt %. For example, the carbon yield of the cured product, as measured by TGA, generally may be from 35 wt % to 95 wt % in one embodiment, from 40 wt % to 90 wt % in another embodiment, from 45 wt % to 85 wt % in still another embodiment, or from 50 wt % to 80 wt % in yet another embodiment, based on the total weight of the cured composition. In other embodiments, the carbon yield of the cured product can include 35 wt % or greater, 40 wt % or greater, 45 wt % or greater, or 50 wt % or greater. In other embodiments, the carbon yield of the cured product can include 95 wt % or lower, 90 wt % or lower, 85 wt % or lower, or 80 wt % or lower.

Upon curing the curable liquid carbon precursor composition having a neat viscosity of less than 10,000 mPa-s at 25° C., the resultant cured composition is adapted for being carbonized or further processed. Upon curing the curable liquid carbon precursor composition, the cured composition comprises a solid body which can be formed or shaped into a desired preform structure before carbonizing the structure.

The resulting cured material (i.e., the cross-linked product) produced from curing the curable liquid carbon precursor composition described above forms a cured preform precursor that can be carbonized in accordance with the present invention to further form a carbonized composition or carbonized product (the porous carbon composition) with several improved properties.

In one embodiment, the curing step described above can be carried out concurrently with the carbonizing step in whole or in part. In another embodiment, the carbonizing step can be carried out as a separate step from the curing step.

For example, the process of the present invention can include the step of carbonizing the cured material in an inert atmosphere such as nitrogen or vacuum at a predetermined temperature and for a predetermined period of time sufficient to carbonize the cured material that has a carbon yield of greater than 35 wt %. For example, the temperature of carbonizing the cured material may be generally from 350° C. to 4,000° C. in one embodiment; from 400° C. to 3,500° C. in another embodiment; from 500° C. to 3,000° C. in still another embodiment; and from 800° C. to 2000° C. in yet another embodiment.

Generally, the time of carbonizing the cured material may depend on the amount of carbon material, the size of the carbon article, and the complexity of the carbon article. In one illustrative embodiment, the time of carbonizing the cured material can be chosen for example in the range from 1 minute to 90 days in one embodiment, from 30 minutes to 7 days in another embodiment, and from 1 hour to 24 hours in still another embodiment.

One advantage of the carbonized composition of the present invention is that the carbonized composition has a low amount of impurities. The impurities can include for example metals and non-metals. The presence of impurities in the carbonized composition may introduce deleterious effects in the properties of the resulting carbonized material in its various applications.

After curing the liquid formulation containing the porogens and then carbonizing the cured carbon matrix; any number of other optional heat treatments; and/or further fabrication methods may be employed in the present invention.

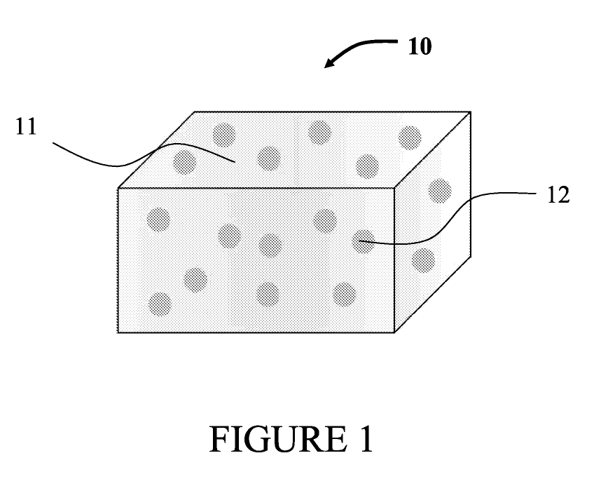

For example, with reference to FIG. 1-3, there are shown schematic illustrations of successive resin blocks following each of the processing steps in sequential order representing the process step for manufacturing a carbon foam of the present invention. Beginning with FIG. 1, there is shown, for example, a curable liquid carbon precursor formulation generally indicated by numeral 10 including for liquid matrix 11 with porogen particles 12. The porogen particles shown in FIG. 1 are present in the liquid formulation before the formulation has undergone curing or carbonization.

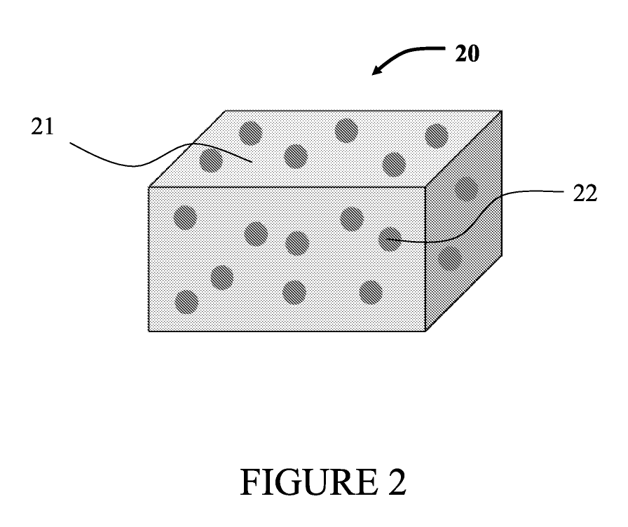

With reference to FIG. 2, there is shown a second processing step following the step of FIG. 1, wherein a cured product, generally indicated by numeral 20, includes a cured matrix 21 with porogen particles 22 which may or may not remain the same as particles 12. FIG. 2 illustrates that the previous porogens 12 in the body of the curable liquid formulation and are now porogen particles 22 embedded in the cured liquid formulation 21.

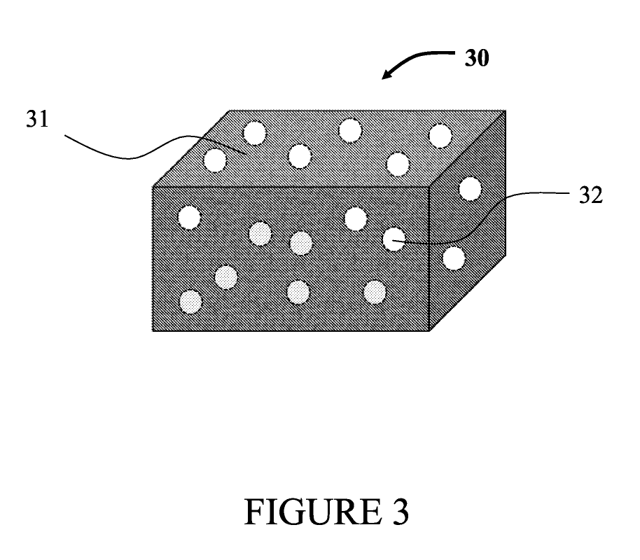

With reference to FIG. 3, there is shown a third processing step following the step of FIG. 2 wherein a carbonized product, generally indicated by numeral 30, including a carbon matrix 31 and pores or voids 32 resulting from carbonization of the cured formulation of FIG. 2. The resulting pores 32 in the carbon matrix 31 provide a foamed structure 30.

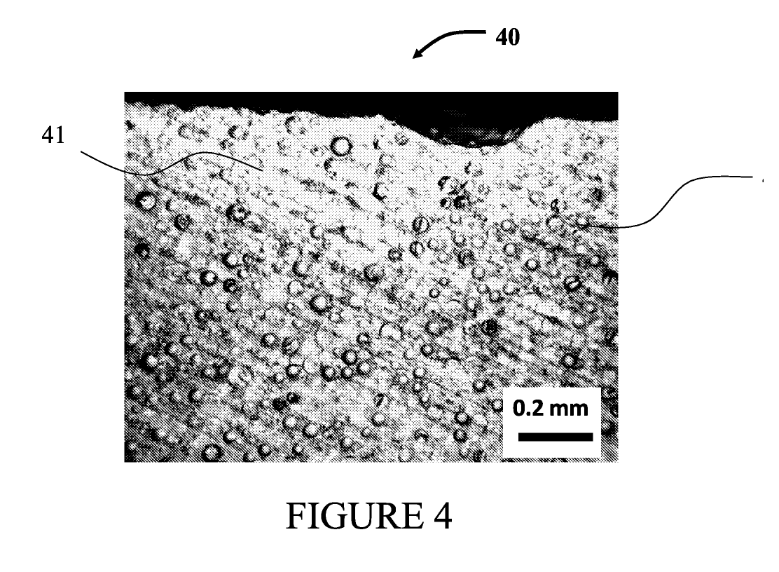

FIG. 3 shows a porous carbon composition of the present invention after carbonization of the cured composition of FIG. 2. FIG. 4 is a photograph showing a cross-sectional view of a portion of a cured composition of the present invention, generally indicated by numeral 40, as prepared by the curing process above. The cured product 40 is made of a cured matrix 41 and containing particles of porogens 42 before carbonization of the cured carbon composition. FIG. 4 shows a cross sectional view of a portion of a cured liquid carbon formulation with embedded porogen recognizable as spherical nodules in the matrix.

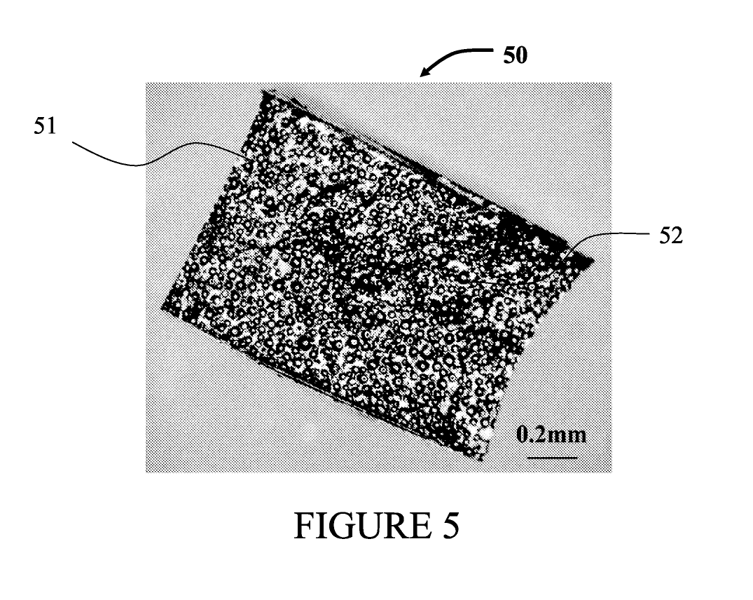

And, FIG. 5 is a photograph showing a porous carbon composition of the present invention after carbonization of a cured carbon composition shown in FIG. 4 including the carbon matrix 51 and the porogen particles 52. FIG. 5 shows a cross sectional view of a portion of a carbonized composition made from the formulation of FIG. 4 wherein the nodules in the matrix (embedded porogen recognizable as spherical nodules in the matrix). Upon carbonizing the cured material, a porous carbon composition product is formed. With reference to FIG. 5, there is shown a photograph of porous carbon composition produced by the process of the present invention. The porous carbon compositions are generally indicated by reference numeral 50 in FIG. 5; and comprises a carbon matrix 51 with voids, or closed cells 52.

The porous carbon composition of the present invention including a carbon/graphite foam may be used to manufacture various porous carbon composition articles such as for example in electronic devices, semiconductors, thermal insulation and conductors, construction materials, electrochemical storage, layer products, separation, high-temperature thermal insulation, high thermally conductive heat sinks, electrodes for energy storage, energy absorption material, catalyst supports and filters, high temperature insulation, fuel cell electrodes, heat exchangers, brake disks, engine components, and bone surgery materials.

### EXAMPLES

The following examples further illustrate the present invention in detail but are not to be construed to limit the scope thereof.

Various terms and designations used in the following examples are explained herein as follows:

“DVBDO” stands for divinylbenzene dioxide having a purity of at least 95%.

“MPTS” stands for methyl p-toluenesulfonate.

“TGA” stands for thermogravimetric analysis.

The following standard analytical equipments and methods are used in the examples:

Measurement of Viscosities of the Precursor Composition

The viscosity of the curable liquid carbon precursor formulation of the present invention was measured on a torsional rheometer TA Instruments AR2000 equipped with a 50 mm diameter smooth stainless steel upper plate and a bottom Peltier plate assembly controlling both the temperature of the liquid sample and the normal force acting on the surface of the Peltier plate. About 2 mL of the formulation was deposited on the bottom plate before the top plate was lowered onto the liquid formulation until a gap of 300 microns between the two plates was achieved. The top plate was then rotated at a nominal rate of 0.001 rad/s while the temperature of the bottom plate was raised from 25° C. to 65° C. at a rate of 10° C./minute. Viscosity was automatically calculated by the TA software and reported as a function of the temperature.

Measurement of Carbon Yield:

Carbon yield (% C) was determined by thermogravimetric analysis under nitrogen using a TA Instruments Q5000 Thermogravimetric Analyzer with a temperature ramp of 10° C./minute from 25° C. to 1,000° C. The “% C” is defined as the wt % residue of carbon at the completion of the above analysis.

### Example 1

In this Example 1, a closed cell porous carbon composition was produced using a porogen which was a 100-200 Dowex™ 1×8 ion exchange resin commercially available from The Dow Chemical Company.

About 35% in weight of the porogen was added to a curable liquid carbon precursor formulation made of a mixture of DVBDO, p-cresol and MPTS at a 85/14/1 weight ratio. The resulting formulation was shaken for about 1 minute in a Flack Tek Inc. Speedmixer (a high shear mixer).

The formulation was poured into a mold to form a disc shaped member and then the formulation was cured according to the following curing schedule:

| | Temp (° C.) | | | | | | | | | | | |
|---|---|---|---|---|---|---|---|---|---|---|---|---|
| | 60 | 80 | 100 | 110 | 120 | 130 | 140 | 150 | 160 | 175 | 200 | 220 |
| Time (minutes) | 15 | 15 | 30 | 15 | 15 | 15 | 15 | 15 | 15 | 15 | 15 | 15 |

The disc shaped cured formulation was approximately 7 cm in diameter with a thickness of about 1.5 mm. A 1.8 mg sample cutout section from the center of the above disc (i.e., a portion of the above resulting cured carbon precursor composition) was pyrolyzed in a TGA Q500 from 25° C. to 1,000° C. at 10° C./minute such that a porous carbon composition was produced as shown in FIG. 5.

Some of the advantageous of the above resulting porous carbon composition may be shown, for example, by measuring the porous carbon composition's following properties: density, insulation properties, adsorptive properties, structural strength, purity (ash content), pressure drop, permeability, and processability by methods known in the art.

1. A curable liquid carbon precursor formulation for preparing a porous carbon composition comprising;
(a) at least one aromatic epoxy resin;
(b)(i) at least one aromatic co-reactive curing agent, (b)(ii) at least one catalytic curing agent, or (b)(iii) a mixture thereof; and
(c) at least one porogen;
wherein the liquid composition has a neat viscosity of less than 10,000 mPa-s, at 25° C. prior to adding porogen, prior to adding optional components, prior to curing, and prior to carbonizing; and wherein the liquid composition being cured has a carbon yield of at least 35 weight percent disregarding the weight of the porogen and any optional components present in the composition.

2. The formulation of claim 1, wherein the porogen comprises a blowing agent, a dispersed gas, a sacrificial template, a hollow material, or combinations thereof.

3. The formulation of claim 2, wherein the blowing agent comprises a liquid having a boiling point of less than 150° C.; and wherein the liquid comprises liquid hydrocarbon, fluorocarbon, chlorocarbon, chlorofluorocarbon, and mixtures thereof.

4. The formulation of claim 2, wherein the dispersed gas comprises a gas having a boiling point of less than 20° C.; and wherein the dispersed gas comprises air, nitrogen, gaseous hydrocarbons, carbon dioxide, and mixtures thereof.

5. The formulation of claim 2, wherein the sacrificial template comprises a polymer particle having a thermal degradation of less than 600° C.

6. The formulation of claim 2, wherein the hollow material comprises any shape such as spheres, tubes, cylindrical, discs, cubes, stars, and mixtures thereof.

7. The formulation of claim 1, wherein the epoxy resin or the curing agent comprises a porogen.

8. The formulation of claim 1, wherein the formulation comprises a solvent-free low viscosity liquid aromatic epoxy resin; and wherein the liquid aromatic epoxy resin liquid formulation comprises at least one divinylarene dioxide.

9. The formulation of claim 1, including (d) at least one curing catalyst.

10. A cured carbon precursor composition for preparing a porous carbon composition comprising a cured reaction product of a curable liquid carbon precursor formulation of claim 1, wherein the cured carbon precursor composition has a carbon yield of at least 35 weight percent as measured in the absence of porogen and any optional components.

11. The cured carbon precursor composition of claim 10, wherein the at least one porogen generates pores during curing to form a cured porous carbon precursor composition.

12. The cured carbon precursor composition of claim 10, wherein the at least one porogen comprises a dispersed gas, a blowing agent, or mixtures thereof.

13. A porous carbon composition comprising a carbonized reaction product of a cured composition prepared from a curable liquid carbon precursor formulation of claim 1.

14. The porous carbon composition of claim 13, wherein the at least one porogen generates pores during carbonization to form a foamed carbon composition.

15. The porous carbon composition of claim 14, wherein the at least one porogen comprises a sacrificial template.

16. A process for preparing a curable liquid carbon precursor formulation for preparing a porous carbon composition comprising admixing (a) at least one aromatic epoxy resin; (b)(i) at least one aromatic co-reactive curing agent, or (b)(ii) at least one catalytic curing agent, or (b)(iii) a mixture thereof; and (c) at least one porogen; wherein the liquid composition has a neat viscosity of less than 10,000 mPa-s, at 25° C. prior to adding porogen, prior to adding optional components, prior to curing, and prior to carbonizing; and wherein the liquid composition being cured has a carbon yield of at least 35 weight percent disregarding the weight of the porogen and any optional components present in the composition.

17. A process for preparing a cured carbon precursor composition comprising the steps of:
(I) providing a curable liquid carbon precursor formulation of claim 1 for preparing a porous carbon composition; and
(II) curing the formulation of step (I) to form a cured carbon precursor composition; wherein the cured carbon precursor composition has a carbon yield of at least 35 weight percent disregarding the weight of the porogen and any optional components present in the composition.

18. A process for preparing a porous carbon composition comprising the steps of:
(I) providing a curable liquid carbon precursor formulation of claim 1 for preparing a porous carbon composition;
(II) curing the formulation of step (I) to form a cured carbon precursor composition; wherein the cured carbon precursor composition has a carbon yield of at least 35 weight percent disregarding the weight of the porogen and any optional components present in the composition; and
(III) carbonizing the cured carbon precursor composition of step (II) to form a porous carbon composition.

19. The process of claim 18, including a step of foaming the formulation of step (I) prior to curing the formulation in step (II).

20. The process of claim 18, including a step of simultaneously foaming and curing the formulation of step (I).

21. The process of claim 18, including a step of shaping the cured product of step (II) prior to the carbonizing step (III).

22. The process of claim 18, wherein the at least one porogen generates a foam structure during curing, carbonization, or a combination thereof.

23. A cured porous article prepared by the process of claim 17.

24. A carbonized porous carbon composition article prepared by the process of claim 18.

25. The carbonized porous article of claim 24 comprising a thermal insulation material.
